(19) United States
(12) Patent Application Publication
(10) Pub. No.: US 2019/0267845 A1
(43) Pub. Date: Aug. 29, 2019

(54) SYSTEMS AND METHODS FOR HIGH-POWER WIRELESS POWER TRANSFER WITH DUAL-QI COMPATABILITY

(71) Applicant: ChargEdge, Inc., Fremont, CA (US)

(72) Inventor: Sanjaya Maniktala, Fremont, CA (US)

(21) Appl. No.: 16/287,660

(22) Filed: Feb. 27, 2019

Related U.S. Application Data
(60) Provisional application No. 62/636,057, filed on Feb. 27, 2018.

(51) Int. Cl. H02J 50/12; H01F 38/14; H04B 5/00

(52) U.S. Cl. CPC H02J 50/12; H04B 5/0081; H04B 5/0037; H01F 38/14

(57) ABSTRACT

Systems and methods are provided herein for providing wireless power from a wireless power transmitter. The transmitter includes a rectifier comprising a first coil coupled with a second coil and a switch having a first switch state and a second switch state and an output electrically coupled to a node between the first coil and the second coil. In the first switch state, the rectifier is configured to output a first current having a first polarity through the first coil and a second current having a second polarity through the second coil, the first polarity and the second polarity are different. And in the second switch state, the rectifier is configured to output a third current having a third polarity through the first coil and the second coil.

### CROSS-REFERENCE TO RELATED APPLICATION

This application claims the benefit of U.S. Provisional Patent Application No. 62/636,057, entitled “High-Power Wireless Power Transfer with Dual-Qi Compatibility,” filed on Feb. 27, 2018, the subject matter of which is hereby incorporated by reference in its entirety.

### FIELD OF THE INVENTION

The present invention generally relates to systems and methods for high-power wireless power transfer with dual-Qi compatibility.

### BACKGROUND

Wireless power transfer (WPT) involves the use of time-varying magnetic fields to wirelessly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a smartphone or other portable device.

The Wireless Power Consortium (WPC) was established in 2008 to develop the Qi inductive power standard for charging and powering electronic devices. Powermat is another well-known standard for WPT developed by the Power Matters Alliance (PMA). There also have been some market consolidation efforts to unite into larger organizations, such as the AirFuel Alliance consisting of PMA and the Rezence standard from the Alliance For Wireless Power (A4WP).

Early versions of both the Qi and Powermat standards fixed the peak resonant frequency of the wireless power transfer process at 100 kHz for Qi and 277 kHz for Powermat. These fixed values are based on the nominal values of the primary inductance of the transmitter coil and the primary capacitance of the associated transmitter-side resonant capacitor in series with the transmitter coil. The operating frequency for transmitters called for in these standards is based on these assumed fixed resonant frequencies. In actual wireless power transmitters the peak resonant frequency is not fixed but is rather a function of the nominal inductance and capacitance values of the transmitter coil and capacitor and other factors such as component variations, load, and leakage. Different wireless power receivers may put different loads on a particular wireless power transmitter, and power leakage varies depending on how well-aligned a wireless power receiver's coil is to the transmitter coil. The entire behavior of the wireless power transfer system is affected by variations in the actual resonant frequency of a wireless power transmitter.

Later versions of these standards allow for slight variations in the operating frequency away from the assumed fixed resonant frequency, but these variations still rely on the basic assumption that the resonant frequency of the transmitter is a known, fixed value based on the nominal inductance of the transmitter coil (measured without being magnetically coupled to a receiver coil) and the nominal capacitance of the resonant capacitor. The Qi standard still requires that the receiver is tuned to a fixed frequency, the fixed frequency being tuned to the assumed fixed resonant frequency of the transmitter, i.e., 100 KHz. The assumed resonant frequency is determined from the measurement of the receiver coil inductance without being in proximity to a transmitter coil and the receiver resonant capacitor. In actual operating Qi systems, while the transmitter and receiver are magnetically coupled, variable resonant frequencies are generated, which is not just unpredictable but adversely affects the ability to deliver more power. As maximum power transfer in a wireless power system occurs when the operating frequency is close to or at the resonant frequency, an incorrect assumption about the resonant frequency affects the ability of the system to deliver close to maximum power. The incorrect assumption about the resonant frequency also creates anomalies in the control loop. For example, in the Qi and PowerMat systems, when the receiver requests an increase in power, the Qi and Powermat systems lower the operating frequency of the transmitter to be closer to the assumed fixed resonant frequency. As the actual (and varying) resonant frequency was often higher than the assumed resonant frequency, the delivered power would decrease instead and the transmitter would turn off due to this anomaly, sometimes referred to as “control inversion.” For example, if the actual resonant frequency of a wireless power transfer system is 150 kHz but the assumed resonant frequency is 100 kHz, the system may adjust the operating frequency closer to 100 kHz in an attempt to increase the delivered power but may actually be lowering the delivered power by moving too far away from the actual resonant frequency. An operating frequency that is too far from the actual resonant frequency can also cause large unanticipated voltage peaks in the resonant components in both the receiver and the transmitter. The reliability of the wireless power transfer system thus can also be affected by assuming an incorrect fixed resonant frequency.

Another drawback of assuming a fixed resonant frequency for a wireless power system is that the operating frequency may be set at a frequency lower than the actual resonant frequency, which causes the overall behavior of the wireless power transmitter coil and capacitor (the “LC tank”) to be capacitive. When the overall behavior of the LC tank is capacitive, switching losses occur in the transistor bridge circuit that generate a time-varying current applied to the transmitter coil, lowering efficiency.

Furthermore, in conventional inductive power transfer systems, such as Qi, the Qi standard still requires that the receiver be tuned to a fixed frequency, the same as the assumed fixed resonant frequency of the transmitter, i.e., 100 KHz. Therefore, in order to maintain the fixed frequency while still responding to varying power needs of a receiver, power transfer systems vary the input voltage of the transmitter using a high-powered DC-DC converter. Along with being costly and cumbersome to implement, varying the input voltage of the transmitter while maintaining the fixed frequency ensures that the transmitter cannot possibly cater to conflicting power demands from multiple receivers, limiting the system to be a one-to-one system, where one transmitter can only support the power needs of a single receiver.

Thus, there is a long felt need for a single transmitter to support the power needs of more than one receiver in a wireless power transfer system.

### BRIEF DESCRIPTION

The systems and methods described herein use a wireless power transmitter to provide wireless power. In an aspect, a wireless power transmitter for providing wireless power includes a rectifier comprising a first coil coupled with a second coil and a switch having a first switch state and a second switch state and an output electrically coupled to a node between the first coil and the second coil. In the first switch state, the rectifier is configured to output a first current having a first polarity through the first coil and a second current having a second polarity through the second coil, the first polarity and the second polarity are different, and in the second switch state, the rectifier is configured to output a third current having a third polarity through the first coil and the second coil.

In some implementations, the wireless power transmitter may include a controller coupled to the switch, where the controller is configured to control the configuration of the switch in the first switch state and in the second switch state. For example, the controller may be configured to open/close the switch depending on the type of receiver (e.g., a Qi receiver or a proprietary receiver) present. For example, the controller may transmit a control signal to open the switch (e.g., drive a transistor acting as the switch “on” by applying a high signal to the transistor's gate) when one or more Qi receivers are present.

In some implementations when the controller is coupled to the switch, the switch may further comprise a transistor, where the transistor receives one or more control signals from the controller, and a diode coupled in parallel with the transistor. For example, the controller may transmit control signals to the transistor to turn the transistor “on” or “off” (e.g., sending a control signal to a driver circuit to drive the transistor high or low, respectively). The diode coupled in parallel with the transistor may prevent the transistor from conducting current in either direction when the transistor is “off.”

In some implementations, the diode may comprise at least one of an external diode or a body diode of the transistor. For example, the diode may be an external diode coupled in parallel with the transistor.

In some implementations, when in the first switch state, the controller may further be configured to control the transmitter at a predetermined frequency, where the predetermined frequency is higher than a maximum resonant frequency of the transmitter. For example, the controller may control the transmitter at a predetermined frequency that is higher than the resonant frequency and lower than electromagnetic interference standards testing (e.g., 150 kHz).

In some implementations, the predetermined frequency is a frequency in the range of 141 kHz to 150 kHz. For example, the controller may control the transmitter at a predetermined frequency of 145 kHz.

In some implementations, when in the second switch state, the controller may be further configured to detect a resonant frequency of the transmitter, determine an optimized frequency that is at least 2% greater than the detected resonant frequency, and vary the phase of the rectifier to control the transmitter at the optimized frequency. For example, the controller may determine the resonant frequency from the peak resonant voltage waveform that results from a frequency sweep (e.g., from 300 kHz to 75 kHz).

In some implementations, the wireless power transmitter may include a ferrite wall between the first coil and the second coil, where the ferrite wall is configured to decease a flux leakage between the first coil and the second coil by providing a flux pathway for a first flux from the first coil and a second flux from the second coil.

In some implementations, the wireless power transmitter may include a biasing resistor coupled to the node, where the biasing resistor is configured to set a positive voltage at the node, wherein the node is further coupled to the switch, the first coil, and the second coil.

In some implementations, the wireless power transmitter may include a first LC tank, comprising a first capacitor coupled in series the first coil, wherein the first LC tank has a first resonant frequency and a second LC tank, comprising a second capacitor coupled in series with the second coil, wherein the second LC tank has the first resonant frequency.

In some implementations, the wireless power transmitter may include a ferrite sheet beneath the first coil and the second coil, where the ferrite sheet is magnetically coupled to the first coil and the second coil.

In another aspect, a method for providing wireless power from a transmitter includes controlling the transmitter to operate in a first state at a predetermined frequency, the predetermined frequency being higher than a resonant frequency of the transmitter, controlling the transmitter to operate in a second state at a variable frequency, and, in the second state, modulating a phase of the transmitter such that an operating frequency of the transmitter is at least 2% greater than the resonant frequency of the transmitter.

In some implementations, the predetermined frequency is a frequency in the range of 141 kHz to 150 kHz. For example, a controller may control the transmitter at a predetermined frequency of 145 kHz.

In some implementations, when controlling the transmitter to operate in the first state, the method further includes detecting the presence of at least one Qi receiver. For example, a controller may receive data packets from one or more Qi receivers indicating the presence of one or more Qi receivers.

In some embodiments, in response to detecting the presence of a first Qi receiver, the method further includes controlling a first branch of the transmitter at the predetermined frequency and controlling a second branch of the transmitter such that it transmits a nominal amount of power.

In some implementations, in response to detecting the presence of a first Qi receiver and a second Qi receiver, the method further includes controlling a first branch of the transmitter and a second branch of the transmitter at the predetermined frequency. For example, a controller may operate the transmitter at a predetermined frequency between 141 kHz and 150 kHz.

In some implementations, when controlling the first branch of the first transmitter and the second branch of the second transmitter at the predetermined frequency, the method further includes controlling a first duty cycle of a first rectifier of the first branch and controlling a second duty cycle of a second rectifier of the second branch, where the first duty cycle and the second duty cycle are different.

In some implementations, when operating the transmitter in the first state, the method further includes detecting the resonant frequency of the transmitter, where the resonant frequency varies in response to varying power requests from a receiver. For example, the controller may determine the resonant frequency from the peak resonant voltage waveform that results from a frequency sweep (e.g., from 300 kHz to 75 kHz).

In some implementations, when controlling the transmitter to operate in the second state, the method further includes detecting a resonant frequency of the transmitter and determining the optimized frequency of the transmitter that is at least 2% greater than the detected resonant frequency.

In some implementations, when controlling the transmitter to operate in the second state, the method further includes receiving a request from a receiver coupled to the transmitter requesting that the transmitter transmit more power to the receiver and increasing the phase of the transmitter to transmit more power to the receiver while maintaining the optimized operating frequency. For example, the transmitter may receive one or more data packets from the receiver indicative of a request for more power. In response, the phase of the transmitter may be increased to transmit more power to the receiver.

In some implementations, when controlling the transmitter to operate in the second state, the method further includes receiving a request from a receiver coupled to the transmitter requesting that the transmitter transmit more power to the receiver and decreasing the phase of the transmitter to transmit less power to the receiver while maintaining the optimized operating frequency. For example, the transmitter may receive one or more data packets from the receiver indicative of a request for less power. In response, the phase of the transmitter may be decreased to transmit less power to the receiver.

### BRIEF DESCRIPTION OF THE FIGURES

FIG. 1 is a diagram of one embodiment of a wireless power transmitter in a transverse field mode, according to certain implementations.

FIG. 2A is a diagram of one embodiment of the voltage detector of FIG. 1, according to certain implementations.

FIG. 2B is a diagram of one embodiment of the waveforms resulting from the voltage detector of FIG. 2A, according to certain implementations.

FIG. 3 is a diagram of one embodiment of the transmitter with a ferrite wall, according to certain implementations.

FIG. 4A is a diagram of the transmitter operating in dual-Qi mode, according to an embodiment of the invention.

FIG. 4B is a diagram of the transmitter operating in dual-Qi mode when a single receiver is present, according to an embodiment of the invention.

FIG. 5 is a diagram of the magnetic flux induced in the dual-Qi mode of operation, according to an embodiment of the invention.

FIG. 6 is a flow chart of a method for operating the transmitter in dual-Qi mode, according to one embodiment of the invention.

FIG. 7 is a timing diagram of the full-bridge rectifier, according to one embodiment of the invention.

FIG. 8 is a timing diagram of the full-bridge rectifier, according to one embodiment of the invention.

FIG. 9 is a diagram of one embodiment of a wireless power transmitter in a proprietary mode, according to certain implementations.

FIG. 10 is a diagram of the magnetic flux induced in the proprietary mode of operation, according to an embodiment of the invention.

FIG. 11 is a timing diagram of a full-bridge rectifier of the transmitter when the phase is 0.5, according to an embodiment of the invention.

FIG. 12 shows an embodiment in which the operating frequency of the transmitter is the resonant frequency of the transmitter when the phase is 0.5, according to certain implementations.

FIG. 13 shows an embodiment in which the operating frequency of the transmitter is greater than the resonant frequency of the transmitter when the phase is 0.5, according to certain implementations.

FIG. 14 is a flowchart of method steps for the operating of a wireless power transmitter, according to one embodiment of the invention.

FIG. 15 is a flow chart of a method for a noise-immune method of communication, according to an embodiment of the invention.

FIG. 16 is an exemplary timing diagram for a noise-immune method of communication, according to an embodiment of the invention.

### DETAILED DESCRIPTION

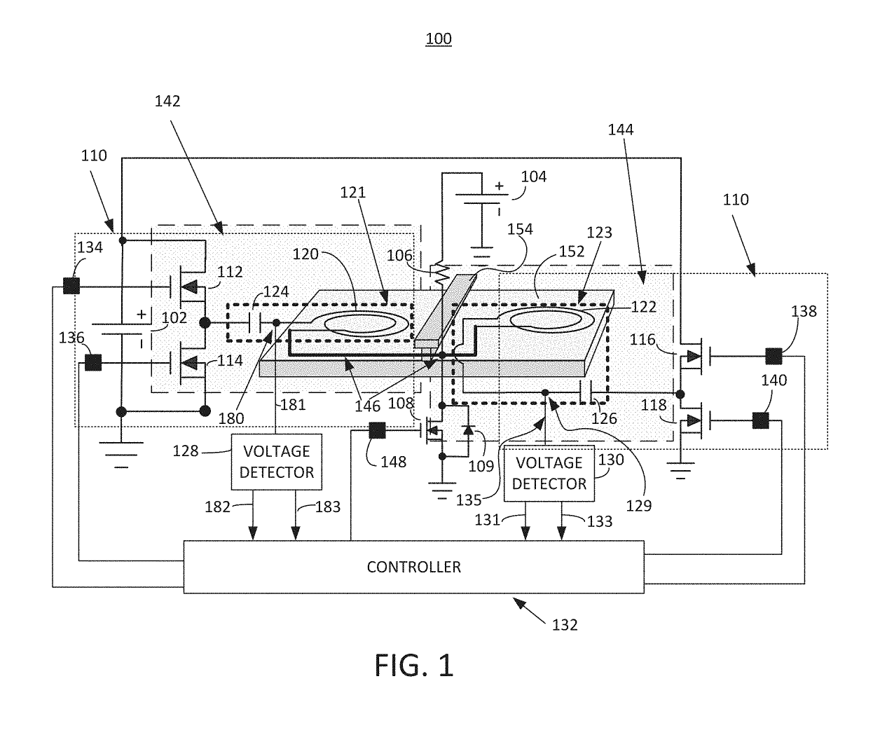

FIG. 1 is a circuit diagram of one embodiment of a wireless power transmitter in a transverse field mode, according to certain implementations. Transmitter 100 includes, but is not limited to: a direct current (DC) voltage supply 102, controller 132 and a full-bridge rectifier circuit 110, branch 142, and branch 144. Full-bridge rectifier 110 is split into a half-bridge rectifier in branch 142 that includes transistor 112 and transistor 114, and a half-bridge rectifier in branch 144 that includes transistor 116 and transistor 118. Transistor 112 (e.g., a high-side transistor) may be coupled in series with transistor 114 (e.g., a low-side transistor). Transistor 116 (e.g., a high-side transistor) may be coupled in series with transistor 118 (e.g., a high-side transistor). Transistor 112 may be coupled in series with transistor 116, and transistors 114 and 118 may be coupled to ground. Full-bridge rectifier circuit 110 further includes LC tank 121 comprising capacitor 124 coupled in series with transmitter coil 120 (e.g., in branch 142) LC tank 123 comprising capacitor 126 coupled in series with transmitter coil 122 (e.g., in branch 144), and link 146 coupling LC tank 121 with LC tank 123. The gates of transistors 112, 114, 116, and 118 are coupled to controller 132 via driver circuitry 134, 136, 138, and 140, respectively.

Transmitter 100 further includes resistor 106 and DC voltage supply 104 to bias link 146, and a switch coupled to link 146, shown in FIG. 1 as transistor 108 coupled in series with diode 109. Controller 132 drives transistor 108 via driver circuitry 148. Voltage detector 128 takes a voltage measurement from branch 142 8 at node 180 (e.g., corresponding to the resonant voltage of LC tank 121), and voltage detector 130 takes a voltage measurement from branch 144 at node 129 (e.g., corresponding to the resonant voltage of LC tank 123). Voltage detector 128 and voltage detector 130 may send the resulting voltage measurements to controller 132 via paths 182, 183, 131, and 133.

Transmitter 100 comprises two branches, branch 142 (e.g., the first branch) and branch 144 (e.g., the second branch). Branch 142 comprises transistor 112, transistor 114, and transmitter coil 120 and capacitor 124 (e.g., LC tank 121). Branch 144 comprises transistor 116, transistor 118, and transmitter coil 122 and capacitor 126 (e.g., LC tank 123). In some embodiments, transistors 112 and 114, and transistors 116 and 118, are in a half-bridge configuration. Controller 132 may independently control and operate each half-bridge rectifier in branch 142 and branch 144, thus independently controlling branch 142 and branch 144. For example, in some configurations, branch 142 may transmit power while branch 144 is “off” (e.g., doesn't transmit power). In other configurations, branch 144 may transmit power while branch 142 is “off” (e.g., doesn't transmit power).

In some embodiments, transmitter coils 120 and 122 are nominally identical coils and capacitors 124 and 126 are nominally identical resonant capacitors. Therefore, the resonant frequencies of branch 142 and branch 144 are the same when transmitter coils 120 and 122 and capacitors 124 and 16 are nominally identical, respectively. The resonant frequency of transmitter 100 (e.g., the overall system) is equal to the resonant frequency of branch 142 (e.g., or branch 144, as they are nominally the same), as disclosed in U.S. Patent Publication No. 20160285319, entitled “Tuned Resonant Microcell-Based Array for Wireless Power Transfer,” filed on Mar. 28, 2016, the subject matter of which is hereby incorporated by reference in its entirety. As long as each LC tank is in series with one another, and each LC tank is tuned to the same resonant frequency, the overall resonant frequency of the system is equivalent to the tuned resonant frequency of an individual LC tank.

In other embodiments, LC tanks 121 and 123 include a plurality of transmitter coils and a plurality of capacitors. In some embodiments, capacitor 124 is comprised of a plurality of capacitors, and in some embodiments, capacitor 126 is comprised of a plurality of capacitors.

Voltage supply 102 provides a DC input voltage for transmitter 100, and in one embodiment is a constant value in the range of 12-15 V. In another embodiment, voltage supply 102 is implemented as a DC-to-DC converter (not shown) that provides a variable DC input voltage to full-bridge 110, and controller 130 provides a control signal to voltage supply 102 to select the input voltage value. In other embodiments, duty cycle control or phase modulation of full-bridge circuit 110 may vary the input voltage value to transmitter coil 120 and capacitor 124 and transmitter coil 122 and capacitor 126. In other embodiments, a combination of a variable input voltage from voltage supply 102, duty cycle variation, and/or other phase modulation may be used to vary the voltage input to transmitter coil 120 and capacitor 124 and transmitter coil 122 and capacitor 126.

Controller 132 provides control signals to the full-bridge rectifier 110 via driver circuits 134, 136, 138, and 140 to drive each of transistors 112, 114, 116, and 118 on or off. Controller 132 further provides control signals to driver circuit 148 to drive transistor 108 on or off. Driver circuits are known to persons of ordinary skill and may include but are not limited to constant current drivers, constant resistor drivers, bootstrap circuitry, an amplifier, or any other comparable type of driver circuit.

Each of transistors 108, 112, 114, 116, and 118 is an n-type MOSFET; however any other type of transistor is within the scope of the invention. In some embodiments, transistors 108, 112, 114, 116, and 118 may all be p-type field effect transistors (FETs). In some embodiments, transistors 108, 112, 114, 116, and 118 may be any combination of p-type or n-type FETs. In some embodiments, transistors 108, 112, 114, 116, and 118 may be bipolar junction transistors, heterojunction bipolar transistors, or any comparable transistor.

Controller 132 controls the timing of switching transistors 112, 114, 116, and 118 on and off to provide alternating current to LC tank 121 and LC tank 123, respectively. In one embodiment, controller 132 will turn on (e.g., apply a “high” signal to the gates of) transistor 112 and transistor 118 while turning off (e.g., applying a “low” signal to the gates of) transistor 114 and transistor 116 during a time interval. During the next time interval, controller 132 will turn on transistor 114 and transistor 116 and turn off transistor 112 and transistor 118. Controller 132 may also provide for “dead time” between the time intervals, during which potentially cross-conducting pairs of transistors in full-bridge rectifier 110, for example transistors 112 and 114 and/or transistors 116 and 118, are simultaneously off. In one embodiment, the dead time has a duration in the range of 100 nanoseconds to 1 millisecond. The timing of switching these pairs of transistors in full-bridge rectifier 110 on and off by controller 132 establishes an operating frequency for transmitter 100. In one embodiment, controller 132 provides control signals to full-bridge rectifier 110 such that it operates as two half-bridge rectifiers.

Branch 142 and branch 144 each have a voltage detector, voltage detector 128 and voltage detector 130, respectively. The voltage detectors detect and rectify the voltage at the resonant voltage nodes in their respective branches. For example, in branch 142, voltage detector 128 detects and rectifies the voltage at resonant voltage node 180. In branch 144, voltage detector 130 detects and rectifies the voltage at resonant voltage node 129. The voltages detected by voltage detector 130 and/or voltage detector 128 are used by controller 132 to determine both the operating frequency of transmitter 100 and the resonant frequency of transmitter 100.

Voltage detector 130 receives as an input a voltage measured between node 131 and ground. Voltage detector 130 detects and rectifies the voltage at node 129 and provides a peak voltage value signal to controller 132 through path 131. The peak voltage value signal tracks the peak amplitude values of the rectified voltage waveform measured at node 129. Voltage detector 130 tracks the peak values of the rectified voltage when transmitter 100 is not under load and also when transmitter 100 is under load from a wireless receiver (not shown). Voltage detector 130 also provides a rectified voltage signal to controller 132 through path 133.

In some embodiments, voltage detector 128 receives as an input a voltage measured between node 180 and ground. Voltage detector 128 detects and rectifies the voltage at node 180 and provides a peak voltage value signal to controller 132 through path 182. The peak voltage value signal tracks the peak amplitude values of the rectified voltage waveform measured at node 180. Voltage detector 128 tracks the peak values of the rectified voltage when transmitter 100 is not under load and also when transmitter 100 is under load from a wireless receiver (not shown). Voltage detector 128 also provides a rectified voltage signal to controller 132 through path 183.

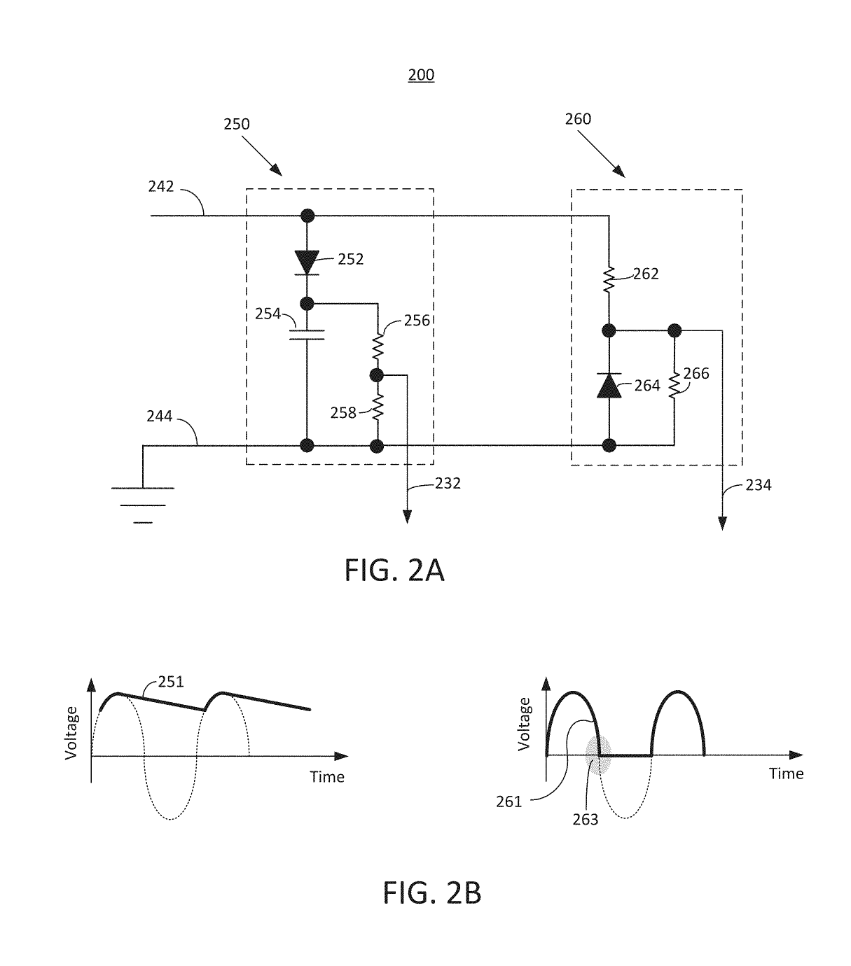

In some embodiments, controller 132 may only receive input from one voltage detector (e.g., either voltage detector 128 or voltage detector 130). Controller 132 many only need to receive input from one voltage detector when branch 142 and branch 144 are run synchronously because branch 142 and branch 144 will be driven at the same operating frequency. Therefore, the difference in output control signals from voltage detector 128 and voltage detector 130 should be nominal (e.g., dependent on the tolerance/actual values of each component in the transmitter). An embodiment of voltage detectors 128 and 130 is discussed further below in conjunction with FIG. 2A.

Controller 132 generates control signals to control full-bridge rectifier 110 and transistor 108. In one embodiment, controller 132 is a microcontroller executing firmware configured to process the peak voltage value signal and the rectified voltage signal from voltage detector 128 and/or voltage detector 130 and to generate the control signals for full-bridge circuit 110. In other embodiments, controller 132 is embodied as a field programmable gate array, a state machine, or an application specific integrated circuit (ASIC) configured to process the signals from voltage detector 128 and/or voltage detector 130 and to generate the control signals.

Controller 132 is configured to detect the varying resonant frequency of transmitter 100. For example, controller 132 is configured to vary the operating frequency of transmitter 100 over a range of frequencies and to process the resulting peak voltage value signal from voltage detector 128 or voltage detector 130 to detect the resonant frequency of transmitter 100.

Controller 132 is further configured to calculate an optimized operating frequency for transmitter 100 based on the detected resonant frequency. The optimized operating frequency for transmitter 100 is approximately 2-15% greater than the actual detected resonant frequency of transmitter 100. In one embodiment, the optimized operating frequency is approximately 5% greater than the detected resonant frequency of transmitter 100. An operating frequency that is approximately 1% to 15% greater than the actual resonant frequency has the effect that LC tank 121 and LC tank 123 appear inductive to full-bridge circuit 110 such that residual current will tend to flow naturally to either of the input supply rails during the dead time, allowing for zero-voltage switching and higher efficiency. By operating transmitter 100 at a frequency that is 2-15% greater than the detected resonant frequency, transmitter 100 provides close to its maximum available power to a wireless power receiver while also enabling zero-voltage switching of full-bridge circuit 110.

An operating frequency that is higher than the actual resonant frequency allows for zero-voltage switching by the transmitter. Zero-voltage switching ensures that the current in any transistor of the bridge switching circuit is momentarily negative (i.e., flowing through its body diode) at the moment that the transistor is switched on. Zero-voltage switching in the transmitter provides minimal switching losses and higher efficiency. If the assumed resonant frequency, which is the incorrect target frequency for maximum power transfer, is significantly less than the actual resonant frequency, there is a higher likelihood that the operating frequency used by the wireless power transmitter will be lower than the actual resonant frequency, preventing zero-voltage switching and lowering efficiency. The control of transmitter circuit 100 is described in more detail below.

Link 146 connects transmitter coil 120 and transmitter coil 122. In some embodiments, link 146 may be a metal link connecting transmitter coil 120 and 122 in a series configuration. For example, conductor 146 may be a wire, a tracing on a printed circuit board, or any other compatible conductive connection. In some embodiments, transmitter coil 120 and transmitter coil 122 are spiral coils laid out on a single ferrite sheet, where the ferrite sheet is magnetically coupled to transmitter coil 120 and transmitter coil 122, as shown in FIG. 1.

Resistor 106 may be coupled between transmitter coil 120 and transmitter coil 122 at position 146 in transmitter circuit 100. Resistor 106 may be a biasing resistor connected to DC power supply 104, fixing the value of the voltage at link 146 to be a set voltage. In some embodiments, resistor 106 may range between 1 kΩ to 10 kΩ and connect to a positive biasing voltage (e.g, DC power supply 104). In some embodiments, DC power supply 104 provide a constant voltage of approximately 5-15 V. In some embodiments, resistor 106 may range between 1 kΩ to 10 kΩ and connect to the positive rail of voltage supply 102. Resistor 106 biases the value of the voltage at link 146 such that there is not reverse conduction through diode 109. Biasing the voltage at link 146 further prevents unintended electromagnetic interference at link 146.

Transistor 108 is coupled between link 146 and ground. Transistor 108 is coupled to diode 109 in a parallel configuration. In some embodiments, diode 109 may be an external diode. In some embodiments, diode 109 may be the intrinsic body diode of transistor 108. Controller 132 may turn transistor 108 on or off via driver circuitry 148.

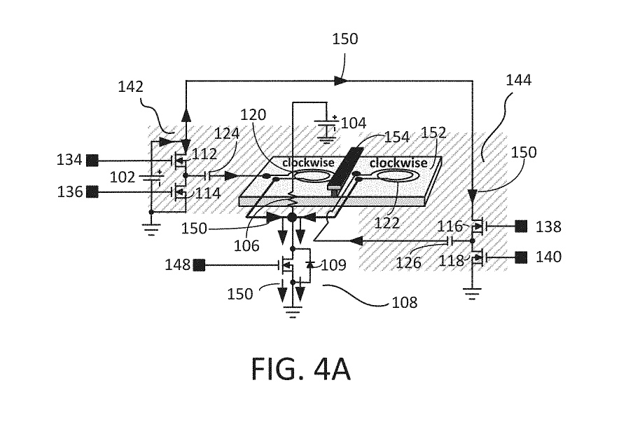

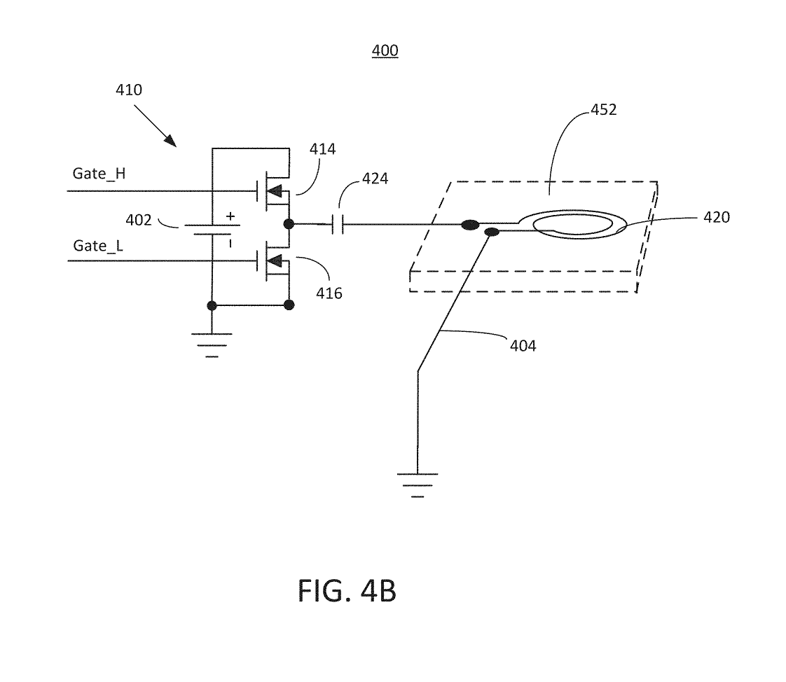

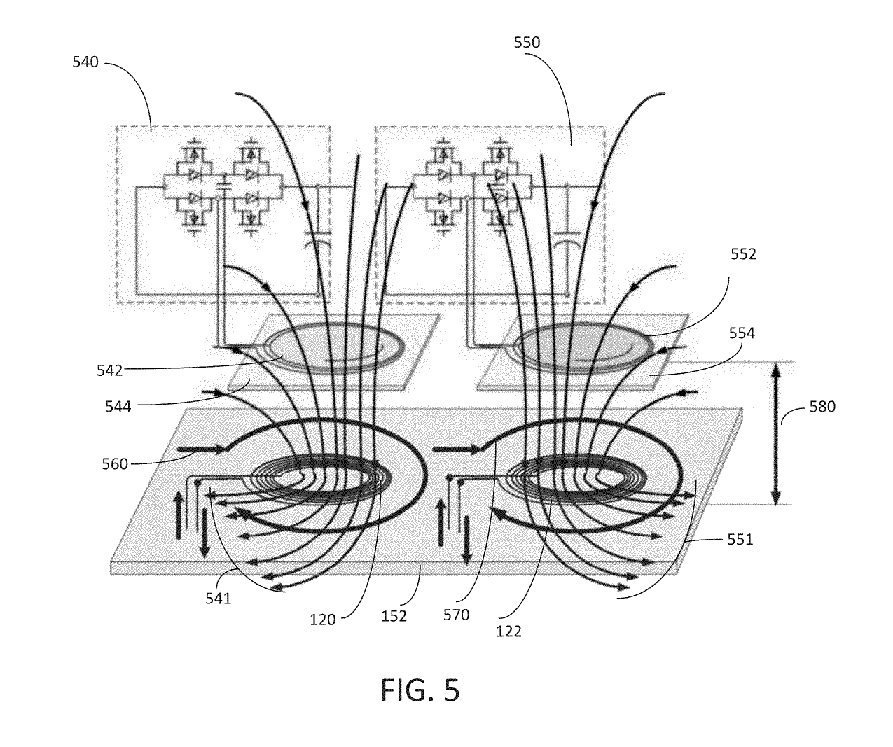

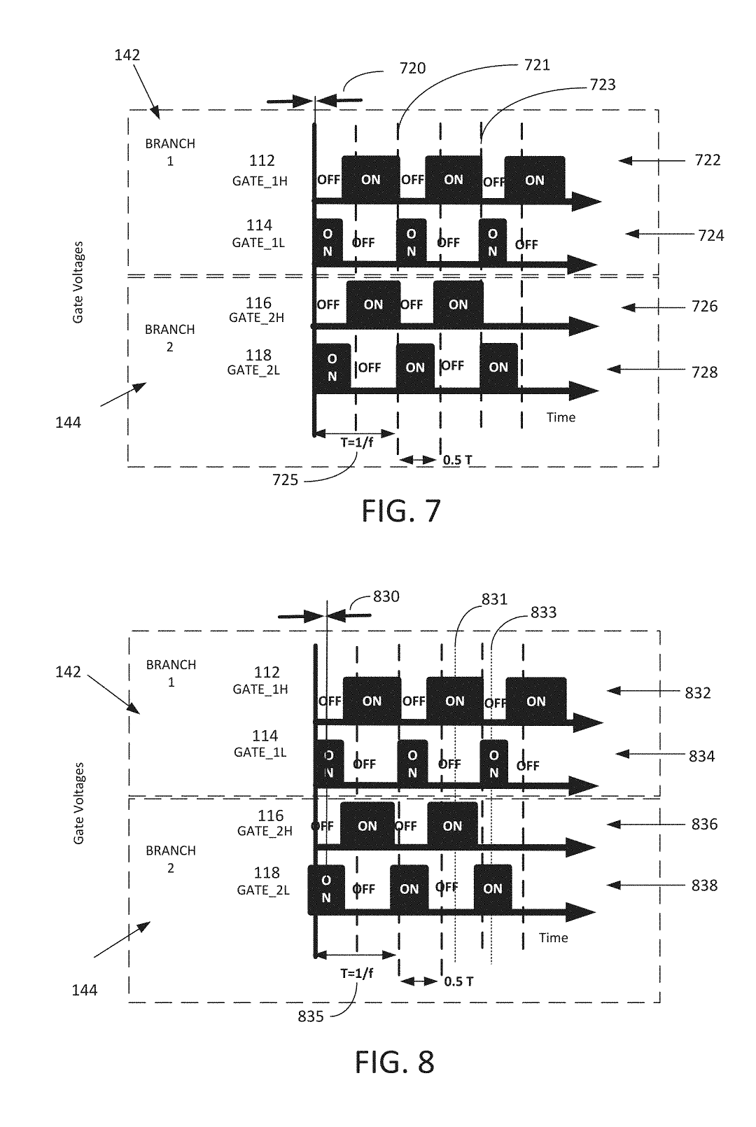

In some embodiments, transmitter coil 120 and transmitter coil 122 are connected, such that the when transistor 108 is conducting (e.g., the gate of the transistor is held high and transistor 108 is “on”), the polarity of the current through transmitter coil 120 and transmitter coil 122 is the same, as shown and described in reference to FIGS. 4A, 4B, and 5. When the gate of transistor 108 is held low (e.g., transistor 108 is “off”), transistor 108 does not conduct in either direction, due to the voltage bias at link 146 from biasing resistor 106. The voltage bias at link 146 reverse biases diode 109, therefore preventing transistor 108 from conducting current in either direction. Therefore, when transistor 108 is off (e.g., the gate of the transistor is held low), the polarity of the current through transmitter coil 120 is different than the polarity of the current through transmitter coil 122, as shown and described in reference to FIGS. 7 and 8. Controller 132 provides control signals to the gate of transistor 108 via driver circuit 148 to drive transistor 108 on/off, as described below.

FIG. 2A is a diagram of one embodiment of the voltage detector of FIG. 1, according to certain implementations. Voltage detector 200 includes but are not limited to a peak voltage detector circuit 250 and a voltage magnitude detector circuit 260. Peak voltage detector circuit 250 includes a diode 252 coupled in series with a capacitor 254, a resistor 256, and a resistor 258. In one embodiment, capacitor 254 has a capacitance value of approximately 1 nF, resistor 256 has a resistance value of approximately 200 kΩ, and resistor 258 has a resistance value of approximately 10 ka Path 232 is coupled to a location between resistor 256 and resistor 258 to provide the peak voltage value signal to controller 132. The resistor divider of resistor 256 and resistor 258 scales down the detected voltage to levels appropriate to be input to controller 132. Voltage magnitude circuit 260 includes a resistor 262, a diode 264, and a resistor 266. In one embodiment, resistor 262 has a resistance value of approximately 200 kΩ and resistor 266 has a resistance value of approximately 10 ka Path 234 is coupled to voltage magnitude circuit 260 to provide the voltage magnitude signal to controller 132. The resistor divider of resistor 262 and resistor 266 scales down the detected voltage to levels appropriate to be input to controller 132. Voltage detector 128 may be equivalent to voltage detector 200, and voltage detector 130 may also be equivalent to voltage detector 200.

FIG. 2B is a diagram of the resulting waveforms from voltage detector 200. Voltage peak waveform 251 is a rectified and scaled-down representation of the peak voltage waveform at node 242 (e.g., either node 129 or node 180). Voltage magnitude waveform 261 is a rectified and scaled-down representation of the voltage waveform at node 242 (e.g., either node 129 or node 180). Voltage magnitude waveform 261 has a zero crossing at 263.

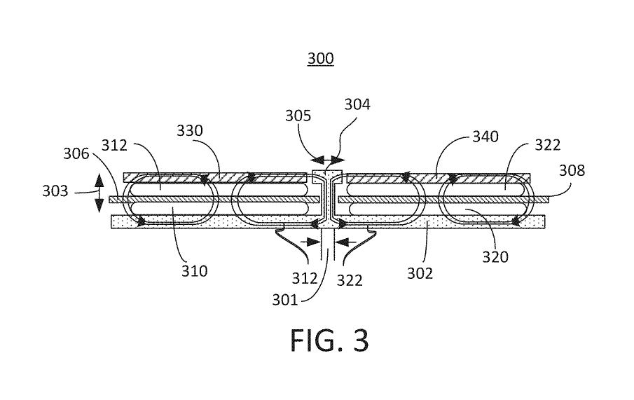

FIG. 3 is a diagram of one embodiment of the transmitter with a ferrite wall, according to certain implementations. FIG. 3 shows a wireless power system 300, which comprises transmitter ferrite 302, ferrite wall 304, plastic barrier 306, plastic barrier 308, first transmitter coil 310, second transmitter coil 320, first receiver 330, second receiver 340, first receiver coil 332, second receiver coil 342, flux lines 312, and flux lines 322. Ferrite wall has a height 303, bottom width 301, and top width 305. Ferrite wall 304 minimizes the flux leakage and interference between flux lines 312 and 322. Ferrite wall 304 provides a path for flux lines 312 and 322 to close their respective loops without jumping over the wall. Flux lines 312 and 322 travel through the ferrite wall instead of over it because ferrite wall 304 presents a lower reluctance path compared to the surrounding air (e.g., the air above ferrite wall 304). In some embodiments, the cross sectional shape of ferrite wall 304 is “T” shape. In some embodiments, the cross sectional shape of ferrite wall 304 may be a square, a rectangle, a semi-circle, mushroom-shaped, or another or comparable shape. In some embodiments, height 303 of ferrite wall 304 should be chosen such that a barrier between receiver 330 and receiver 340 is created. In some embodiments, height 303 of ferrite wall 304 may be chosen to be greater than the height of receiver 330 when placed on top of plastic 306. In some embodiments, height 303 may be at least 5 mm high, bottom width 301 may be at least 2 mm wide, and top width may be at least 2 mm wide. In some embodiments, height 303 may be at least 5 mm high, bottom width 301 may be at least 2 mm wide, and top width may be at least 4 mm wide.

Controller 132 may operate transmitter 100 in two distinct modes, (1) Dual-Qi mode and (2) proprietary mode, both of which will be described in detail in the following paragraphs.

### Dual-Qi Mode

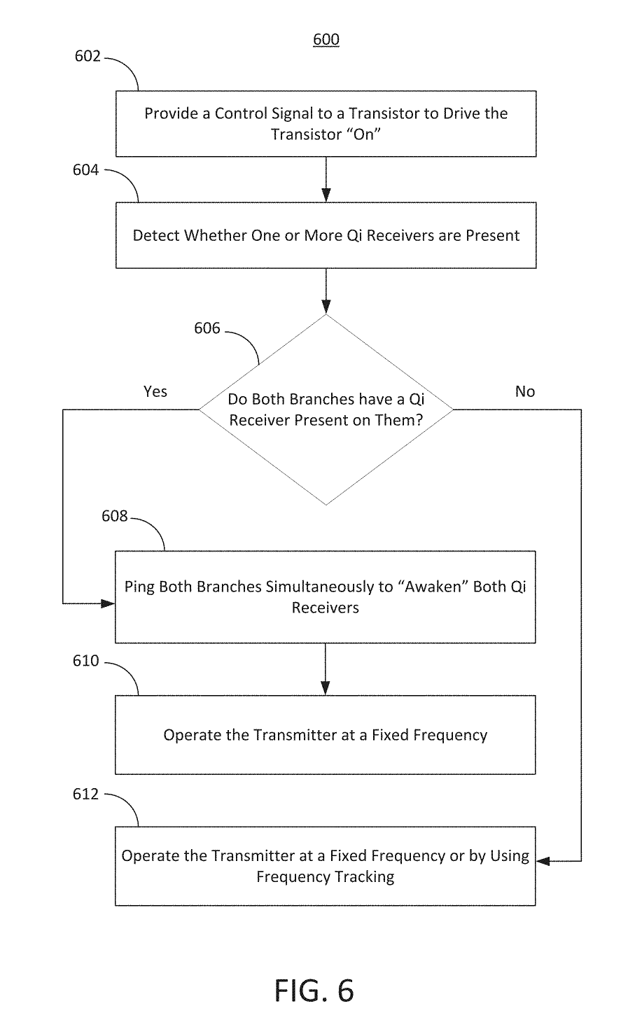

When controller 132 detects the presence of one or more Qi receivers, controller 132 operates transmitter 100 in dual-Qi mode. For example, controller 132 may detect the presence of a Qi receiver after receiving a data packet from said receiver. Detecting the presence of one or more Qi receivers is described in more details in reference to FIG. 6. When operating in dual-Qi mode, controller 132 provides a control signal to driver circuit 148 to drive transistor 108 “on” (e.g., apply a “high” signal to the gate of transistor 108).

FIG. 4A is a diagram of the transmitter operating in dual-Qi mode, according to an embodiment of the invention. When transistor 108 is “on” (e.g., conducting), branch 142 and branch 144 may be operated synchronously. When transistor 108 is “on,” full-bridge 110 is effectively split into two half-bridge rectifiers, with a first half-bridge rectifier corresponding to transistors 112 and 114 in branch 142, and the second half-bridge rectifier corresponding to transistors 116 and 118 in branch 144. Therefore, transmitter 100 may power up to two Qi receivers, one on each branch of transmitter 100.

To power two Qi receivers, one Qi receiver on branch 142 and one Qi receiver on branch 144, controller 132 drives the two half-bridge rectifiers in a specific manner. In some embodiments, controller 132 controls the timing of switching transistors 112, 114, 116, and 118 on and off to provide an alternating current to transmitter coils 120 and 122 and capacitors 124 and 126. In one embodiment, controller 132 will turn on (e.g., apply a “high” signal to the gates of) transistor 112 and transistor 114 while turning off (e.g., applying a “low” signal to the gates of) transistor 116 and transistor 118 during a time interval. During a next time interval, controller 132 will turn on transistor 116 and transistor 118 and turn off transistor 112 and 114 (e.g., driving the two half-bridges in unison). Driving the transistors of the two half-bridge rectifiers in unison induces the current in transmitter coil 120 and transmitter coil 122 to be in a same direction (e.g., the same polarity). For example, as shown in FIG. 4, the current direction in transmitter coil 120 and the current direction in transmitter coil 122 is clockwise. The exemplary direction of the current in FIG. 4 is shown by reference 150.

In one embodiment, in dual-Qi mode when two receivers are present, controller 132 uses a fixed frequency mode to control the switching of the two half-bridge rectifiers. In order to synchronously operate the two branches of transmitter 100 (e.g., branch 142 and branch 144), controller 132 may drive both half-bridge rectifiers at the same operating frequency.

In one embodiment, controller 132 is configured to operate transmitter 100 at a fixed frequency. Controller 132 may process the resulting peak voltage signal from voltage detector 128 (e.g., or voltage detector 130) to detect the operating frequency of transmitter 100. Controller 132 may modify the duty cycle of each of the two half-bridge rectifiers to maintain a fixed operating frequency of transmitter 100. Controller 132 may monitor the operating frequency from the voltage signal from voltage detector 128 (e.g., or voltage detector 130) to identify changes to the operating frequency, and adjust the duty cycle of at least one of the two half-bridge rectifiers to maintain the operating frequency at the fixed value.

In some embodiments, the operating frequency may be a fixed frequency chosen from between 141 kHz and 150 kHz. The range of frequencies in the 141 kHz to 150 kHz band are higher than the maximum resonant frequency of a typical Qi system, which may lie anywhere between 100 kHz and 141 kHz depending on the load and inductance leakage. The range of frequencies in the 141 kHz to 150 kHz band are also lower than the lower limit of electromagnetic interference (EMI) standards testing, which begins at 150 kHz. Therefore, operating transmitter 100 at a frequency above the resonant frequency of the Qi system ensures that LC tank 121 in branch 142 and LC tank 123 in branch 144 operate in an overall inductive manner.

In some embodiments, the operating frequency may be a fixed frequency chose to be 2-20% higher than a detected resonant frequency of transmitter 100. Controller 132 may determine the resonant frequency of transmitter 100 from the voltage signals from voltage detector 128 or from the voltage signals from voltage detector 130. Controller 132 may be configured to calculate an optimized operating frequency for transmitter 100 based on the detected resonant frequency. The optimized operating frequency for transmitter 100 is approximately 2-20% higher than the actual detected resonant frequency of transmitter 100. As stated above, operating transmitter 100 at a frequency above the resonant frequency of the Qi system ensures that capacitor 124 and transmitter coil 120 circuit in branch 142 and the capacitor 126 and transmitter coil 122 circuit in branch 144 operate in an overall inductive manner.

In some embodiments, although the operating frequency of branch 142 and branch 144 is the same fixed frequency, the duty cycle of each branch may be varied to respond separately to the load demands of the two Qi receivers coupled to the two branches. Therefore, duty cycle modulation of the two half-bridge rectifiers allows for the power transmitted from branch 142 and the power transmitted from branch 144 to be independently controlled. For example, if the receiver coupled to branch 142 requests more power (e.g., 5 W) than the receiver coupled to branch 144 (e.g., 3 W), then controller 132 may adjust the duty cycle of the half-bridge rectifier in branch 142 to be higher to the maximum power transfer duty cycle (e.g., when the duty cycle is 0.5, the maximum amount of power is transferred) and may adjust the duty cycle of the half-bridge rectifier in branch 144 to be lower than the duty cycle of half-bridge rectifier in branch 142 while maintaining the same fixed operating frequency for each branch. Therefore, controller 132 may independently control the output power of each branch of transmitter 100.

Furthermore, the synchronous operation of the two half-bridge rectifiers in dual-Qi mode forces largely the same current direction (e.g., polarity) between branch 142 and branch 144, thus creating low electromagnetic interference between the two branches, as explained in reference to FIG. 5.

FIG. 4B is a diagram of the transmitter operating in dual-Qi mode when a single receiver is present, according to an embodiment of the invention. When transistor 108 is “on” (e.g., conducting), and controller 132 detects that only one receiver is present, controller 132 may operate only the branch of transmitter 100 that corresponds to the single receiver. FIG. 4B shows a single branch of transmitter 100 that operates when only one receiver is present. Transmitter branch 400 comprises voltage supply 402, half-bridge rectifier 410 that includes transistor 414 and transistor 416, capacitor 424, transmitter coil 420, ferrite sheet 452, and path 404, controller 132 (not shown), and a voltage detector (not shown). In some embodiments, transmitter branch 400 may be branch 142 or branch 144.

In some embodiments, when only one Qi receiver is present, controller 132 “turn off” the inactive branch of transmitter 100 that does not have a receiver coupled to it. For example, to “turn off” a branch, controller 132 may leave the lower transistor (e.g., either transistor 114 or transistor 118) of the inactive branch (e.g., either branch 142 or branch 144) “on” for a majority of the time, with the lower transistor being turned off only for dead time constraints and any need to switch the upper transistor (e.g., either transistor 112 or transistor 116) “on” in order to keep the driver circuitry (e.g., driver circuit 134 and driver circuit 138) functional.

In some embodiments, transmitter 400 may be operated at a fixed frequency, as described above, using duty-cycle control or input-voltage control (e.g., through the use of a DC-DC converter).

In some embodiments, when only a single receiver is present, controller 132 may control transmitter 400 using frequency tracking for the active branch (e.g., the branch with the corresponding receiver), as described above, where the optimized operating frequency is set to be 2-20% higher than the detected resonant frequency, as explained above. When only a single receiver is present, frequency tracking may be utilized as the electromagnetic interference (e.g., cross-talk) between branch 142 and branch 144 is nominal (e.g., the inactive branch creates a nominal amount of magnetic flux that doesn't interfere with the magnetic flux created by the active branch). Therefore controller 132 may implement frequency tracking of a branch of transmitter 100 when a single receiver is present using phase modulation, duty cycle modulation, or input voltage modulation (via a DC-DC converter), or any combination of the above.

FIG. 5 is a diagram of the magnetic flux induced in the dual-Qi mode of operation. FIG. 5 shows a simplified version of transmitter 100 with transmitter coil 520, transmitter coil 522, first Qi receiver 540, second Qi receiver 550, first magnetic flux 541, and second magnetic flux 551. When the current through the transmitter coil 520 and the current through transmitter coil 522 is in the same direction (e.g., both clockwise or both counterclockwise), a vertical magnetic flux is induced in each transmitter coil in the same direction, per Lenz's law. The magnetic flux is drawn into the Qi receivers' magnetic cores, since the magnetic cores present a lower reluctance path compared to the surrounding air. Therefore, first magnetic flux 541 would repel second magnetic flux 551 and be drawn into first Qi receiver 540, and second magnetic flux 551 would be drawn into second Qi receiver 540, as shown in FIG. 5.

There is low interference (e.g., very little cross-talk) between branch 142 and branch 144 because the magnetic flux induced in each branch is in the same vertical direction, as explained above. Therefore, there is little flux leakage from one branch to the other (e.g., there is little flux leakage between magnetic flux 541 and 551). In previous systems, including the Qi system, flux was not induced vertically (e.g., the current in the two coils was not in the same direction), and flux leakage between two branches of a transmitter circuit created noise and interference when receiving amplitude modulation communication pulses from one or more receivers, causing the communication between the transmitter and receiver to break down, and resulting in turning off transmitter (e.g., per the Qi standard). Therefore, in previous systems, the transmitters with two transmitter coils had to place the two transmitter coils a large distance away from each other to attempt to reduce flux leakage. The current invention mitigates the flux leakage issue by creating a vertical flux, and thus allows the transmitter coils (e.g., transmitter coils 120 and 122) to be placed close together.

FIG. 6A is a flow chart of a method for operating the transmitter in dual-Qi mode, according to one embodiment of the invention. Process 600 starts at step 602, where controller 132 provides control signals to transistor 108 via drive circuit 148 to drive transistor 108 “on” (e.g., apply a “high” signal to the gate of transistor 108). At step 604, controller 132 detects whether Qi receivers are present. In some embodiments, controller 132 may detect one or more Qi receivers on the surface of transmitter 100 by sending a ping at a set frequency (e.g., 175 kHz) for the one or more Qi receivers to respond with data packets. For example, controller 132 may send an alternating ping to each branch (e.g., ping branch 142 first and ping branch 144 second, or vice versa). In some embodiments, controller 132 may “ping” the one or more Qi receivers by operating transmitter 100 at a frequency higher than the resonant frequency, for example 175 kHz.

At step 606, in response to receiving data packets from one or more Qi receivers, controller 132 identifies which branch (e.g., branch 142 and/or branch 144) has a Qi receiver present on it. In some embodiments, when only one Qi receiver is present, controller 132 may turn off the branch that does not have a Qi receiver on it. Transmitter 100 may determine that a branch does not have a Qi receiver on it if controller 132 does not receiver a data packet in response to sending a ping on said branch. For example, if controller 132 determines that branch 144 does not have a Qi receiver on it, controller 132 may turn off branch 144 by providing control signals to driver circuits 138 and 140 to not drive the half-bridge rectifier (e.g., transistors 116 and 118).

If, at step 606, controller 132 determines that “yes,” both branches have a Qi receiver on them, step 606 proceeds to step 308. At step 608, controller 132 pings branch 142 and branch 144 simultaneously to “awaken” both Qi receivers. Controller 132 may ping both Qi receivers by operating transmitter 100 at a frequency higher than the resonant frequency, for example 175 kHz. To avoid the Qi receivers from turning off, controller 132 may sweep the operating frequency of transmitter 100 from 175 kHz to 145 kHz while maintaining a limited duty cycle 20% or less (e.g., to ensure that the Qi receivers receive enough power from the transmitter to create a voltage on the Qi receiver's control circuitry to wake it up, but not enough power to damage the Qi receivers). For example, controller 132 may sweep the frequency of transmitter 100 from 175 kHz to 145 kHz with a duty cycle of 10-15% when the input voltage is between 12-15 V.

At step 610, in response to detecting the presence of one or more Qi receivers, the transmitter is operated at a fixed frequency. In some embodiments, within a finite time of receiving the initial data packets from the one or more Qi receivers, controller 132 provides control signals to transistors 112, 114, 116, and 118 to operate transmitter 100 at a lower operating frequency. For example, controller 132 may operate transmitter 100 at a fixed operating frequency between 141 kHz to 150 kHz, as described above. For example, once controller 132 has completed the frequency sweep from 175 kHz to 145 kHz, both of the Qi receivers will demand more power from transmitter 100 as each Qi receiver connects to their respective load. To provide more power to the Qi receivers while maintaining a fixed frequency (e.g., between 141 kHz and 150 kHz), controller 132 may modulate the duty cycles of each half-bridge rectifier in each branch (e.g., branch 142 and branch 144) to provide the power requested by each Qi receiver. Controller 132 may modulate the duty cycle of each half-bridge rectifier independently based on differing power needs from each Qi receiver (e.g., one branch may have a duty cycle of 30% while the second branch may have a duty cycle of 40% if the second Qi receiver requires more power). Controller 132 may limit the duty cycle for each branch to be between 45-50%. In a half-bridge rectifier configuration, the maximum power transfer occurs at 50% of the duty cycle, and the power transfer at a 40% duty cycle is equivalent to the power transfer at a 60% duty cycle (e.g., same with the power transfer at a 30% duty cycle and a 70% duty, etc.).

Under normal operation, when controller 132 is controlling the half-bridge rectifiers using duty cycle modulation, both branches (e.g., branch 142 and branch 144) normally have different duty cycles (e.g., because each Qi receiver has unique power requirements). In a preferred embodiment, the current through transmitter coil 120 and transmitter coil 122 should be in the same direction for as long as possible (e.g., to reduce interference and EMI, as described above). In one embodiment, to ensure that the currents are in the same direction for as long as possible, controller 132 may send control signals through drive circuits 136 and 140 to ensure that both low-side transistors (e.g., transistor 114 and transistor 118) are turned “on” exactly at the same instant, as shown in FIG. 7. In one embodiment, to ensure that the currents are in the same direction for as long as possible, controller 132 may send control signals through drive circuits 134 and 138 to ensure that both high-side transistors (e.g., transistor 112 and transistor 116) are turned “on” exactly at the same instant, as shown in FIG. 7. In one embodiment, to ensure that the currents are in the same direction for as long as possible, controller 132 may send control signals to ensure that the centers of the control signal both low-side transistors (e.g., transistor 112 and transistor 116) and both high-side transistors (e.g., transistor 114 and transistor 118) coincide, as shown in FIG. 8.

If, at step 606, controller 132 determines that “no,” both branches do not have a Qi receiver on them, then step 606 proceeds to step 612. At step 612, in response to detecting the presence of one Qi receiver, the branch of transmitter 100 corresponding to the detected Qi receiver is operated either at a fixed frequency or is operated using frequency tracking. The branch of transmitter 100 that does not have a corresponding Qi receiver is turned “off” by controller 132. For example, controller 132 may operate the detected branch of transmitter 100 at a fixed operating frequency between 141 kHz to 150 kHz, as described above. As another example, controller 132 may operate the detected branch of transmitter 100 using frequency tracking, as also described above. Controller 132 calculates an optimized operating frequency for transmitter 100 based on the detected resonant frequency. The optimized operating frequency for transmitter 100 is approximately 2-15% greater than the actual detected resonant frequency of transmitter 100, ensuring that the inductive reactance of LC tank 121 or LC tank 123 (e.g., depending on what branch is being operated by controller 132) is greater than the capacitive reactance of LC tank 121 or 123, so the behavior of LC tank 121 or 123 is inductive, therefore allowing for zero-voltage switching of the transistors.

FIG. 7 shows a timing diagram of the full-bridge rectifier, according to one embodiment of the invention. FIG. 7 shows control signals 722, 724, 726, and 728 sent from controller 132 (e.g., through drive circuits) to transistors 112, 114, 116, and 118, respectively. In one embodiment, to ensure that the currents are in the same direction for as long as possible, controller 132 may send control signals through drive circuits 134 and 138 to ensure that both low-side transistors (e.g., transistor 112 and transistor 116) are turned “on” exactly at the same instant, as shown at positions 621 and 623 in the timing diagram. FIG. 7 further shows that although the duty cycles between the control signals 722 and 724 of branch 142 and the duty cycles between the control signals 726 and 728 of branch 144 may be different, frequency 725 is the same in both branches. Phase shift 720 between the rising (or falling) edges of the low-side transistors (e.g., transistors 114 and 118) or the high-side transistors (e.g., transistors 112 and 116) is close to zero degrees in the embodiment of FIG. 7.

FIG. 8 shows a timing diagram of the full-bridge rectifier, according to one embodiment of the invention. FIG. 8 shows control signals 822, 824, 826, and 828 sent from controller 132 (e.g., through drive circuits) to transistors 112, 114, 116, and 118, respectively. In one embodiment, to ensure that the currents are in the same direction for as long as possible, controller 132 may send control signals (e.g., through drive circuits 136 and 140) to ensure that the centers of the control signal of both low-side transistors (e.g., transistor 112 and transistor 116) coincide, as shown at center line 833, and both high-side transistors (e.g., transistor 114 and transistor 118) coincide, as shown at center line 831. FIG. 8 further shows that although the duty cycles between the control signals 822 and 824 of branch 142 and the duty cycles between the control signals 826 and 828 of branch 144 may be different, frequency 835 is the same in both branches. Phase shift 830 between the centers of the control signal of the low-side transistors (e.g., transistors 114 and 118) and between the centers of the high-side transistors (e.g., transistors 112 and 116) is close to zero degrees in the embodiment of FIG. 8.

### Proprietary Mode

When controller 132 detects the presence of one or more proprietary receivers, controller 132 operates transmitter 100 in proprietary mode. When operating in proprietary mode, controller 132 provides a control signal to driver circuit 148 to drive transistor 108 off (e.g., apply a “low” signal to the gate of transistor 108).

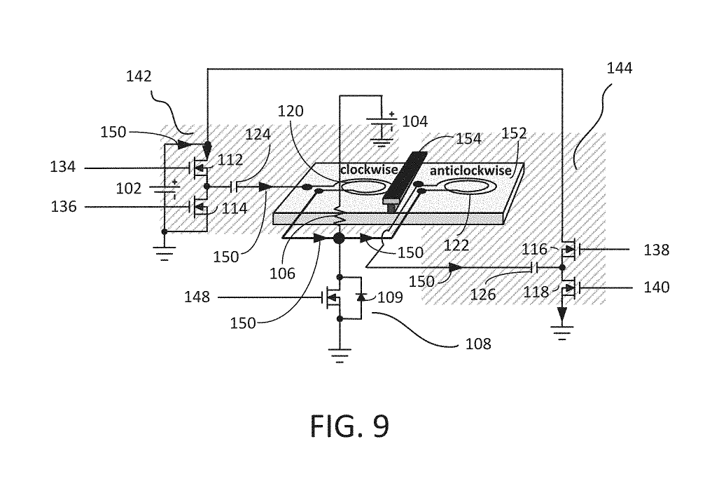

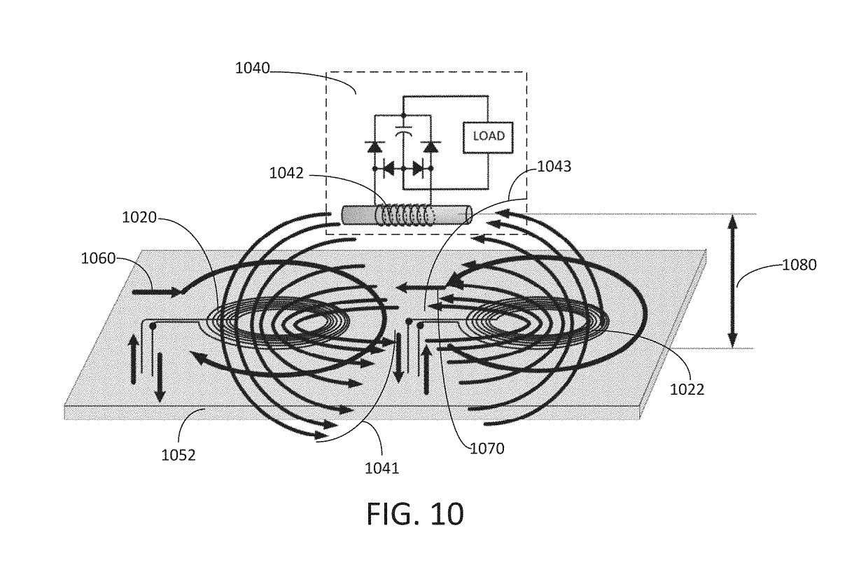

FIG. 9 shows transmitter 100 operating in proprietary mode, with transistor 108 “off,” according to some embodiments of the invention. When transistor 108 is “off,” branch 142 and branch 144 may be operate in an opposite polarity coil structure, as shown and described with reference to FIG. 10. For example, when transistor 108 is “off,” the current through transmitter coil 120 may flow in a first direction (e.g., in a clockwise direction), while at the same time, the current through transmitter coil 122 may flow in a second direction (e.g., in a counterclockwise direction). When transistor 108 is “off,” controller 132 may drive full-bridge rectifier 110 via drive circuits 134, 136, 138, and 140. In some embodiments, controller 132 may control full-bridge rectifier 110 with phase modulation, as described in detail below.

FIG. 10 shows a diagram of the magnetic flux induced in the Proprietary mode of operation. FIG. 10 shows a simplified version of transmitter 100 with transmitter coil 1020, transmitter coil 1022, ferrite sheet 1052, proprietary receiver 1040 with longitudinal receiver coil 1042, first magnetic flux 1041, and second magnetic flux 1043. The distance between transmitter coils 1020 and 1022 and proprietary receiver 1040 is distance 1080. Current flowing through transmitter coil 1020 has current direction 1060, and current flowing through transmitter coil 1022 has current direction 1070. When the current through the transmitter coil 1020 and the current through transmitter coil 1022 is in different directions (e.g., the direction of the current 1060 through transmitter coil 1020 is clockwise and the direction of the current 1070 through transmitter coil 1022 is counterclockwise), a transverse magnetic flux is induced in each transmitter, per Lenz's law. The magnetic flux is drawn into the magnetic core of longitudinal receiver coil 1041 of proprietary receiver 1040, since the magnetic core presents a lower reluctance path compared to the surrounding air. The proprietary receiver is explained in detail in U.S. Patent Publication No. 20170170688, entitled “System For Inductive Wireless Power Transfer For Portable Devices,” filed on Dec. 12, 2016, the subject matter of which is hereby incorporated by reference in its entirety. Therefore, first magnetic flux 1041 would be draw through transmitter coil 1022 and into the longitudinal receiver coil 1042, to close the flux loop. Accordingly, second magnetic flux 1043 would be drawn into the longitudinal receiver 1042 and through transmitter coil 1020, to close the flux loop.

In some embodiments, the proprietary receiver 1040 includes longitudinal receiver coil 1042 that comprises a ferrite core and a helical coil wrapped around the ferrite core. For example, the ferrite core may be in the shape of a cylindrical rod and the helical coil is wrapped around the ferrite core such that the ferrite core and the helical coil share a common longitudinal axis. In one embodiment, proprietary receiver 1040 is optimally oriented such that the longitudinal axis of the ferrite core is substantially parallel to the longitudinal axis of transmitter 100.

In one embodiment, when operating in Proprietary mode, controller 132 may use phase modulation to control full-bridge rectifier 110. As explained above, an output of voltage detector 130 is a peak resonant voltage at node 129 between transmitter coil 122 and capacitor 126. Controller 132 determines the resonant frequency of transmitter 100 from the peak resonant voltage, as described above. In on embodiment, controller 132 may also determine the resonant frequency from an output of voltage detector 128.

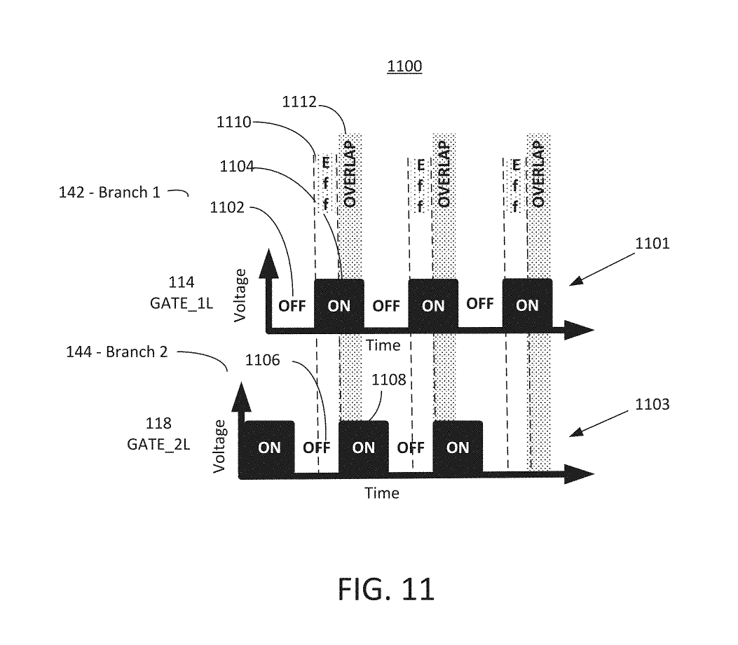

The maximum amount of power transferred in a full-bridge rectifier (e.g., full-bridge 110) occurs when the phase of the full-bridge is 1. Therefore, in some embodiments, when the phase of full-bridge rectifier is less than 1, a partial amount of power is transferred to LC tank 121 and/or LC tank 123 (e.g., transmitter coil 120 and capacitor 124 and/or transmitter coil 122 and capacitor 124). FIGS. 11-13 show diagrams illustrating the relationship between a varying phase of the full-bridge rectifier and the resonant frequency of the transmitter.

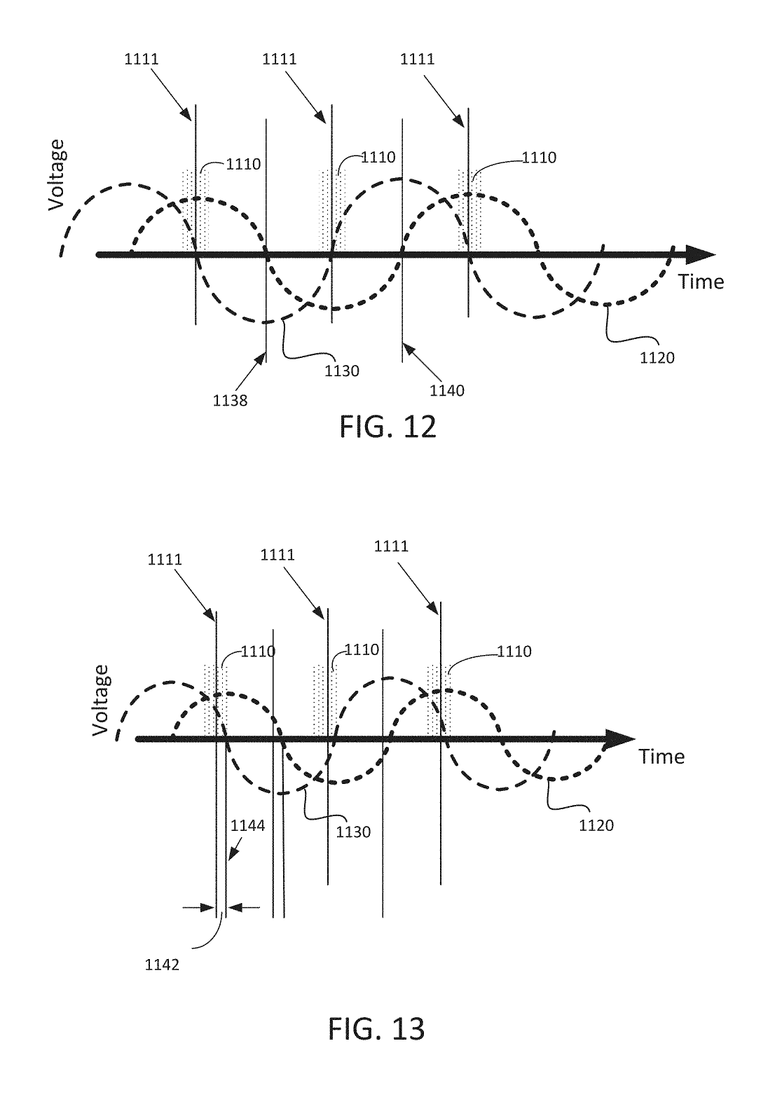

FIGS. 11-13 are diagrams illustrating relationships between an operating frequency and a resulting current and voltage in a wireless power transmitter, according to embodiments of the invention. FIG. 12-13 shows waveforms for a current 1120 and a voltage 1130 of transmitter 100. A low gate waveform 1101 represents the control signal provided to transistor 114 of transmitter 100 by controller 132 (the dead time between pulses is not shown for clarity of illustration). The frequency of the low gate waveform 1101 is also the operating frequency of transmitter 100. Current 1120 represents the coupled current flowing through LC tank 123, which is the component of the current that is passed or transmitted from transmitter 100 (primary) to a wireless receiver (secondary) with primary-to-secondary turns ratio scaling in accordance with well-known principles of transformer action based on Faraday's law of induction. Voltage 1130 waveform represents the coupled voltage detected at node 129 between transmitter coil 122 and capacitor 126, which is the component of the voltage that is passed or transmitted from transmitter 100 to a wireless receiver.

FIG. 11 shows a timing diagram of the full-bridge rectifier when the phase is 0.5, according to one embodiment of the invention. FIG. 11 comprises timing diagram 1100 for the control signals provided from controller 132 to transistor 114 and transistor 118 that determine when transistor 114 and transistor 118 will be on or off. Low gate waveform 1101 corresponds to the control signal provided from controller 132 to transistor 114. Low gate waveform 1103 corresponds to the control signal provided from controller 132 to transistor 118. Low gate waveform 1101 shows that transistor 114 is off at 1102 and on at 1104. Low gate waveform 1103 shows that transistor 118 is off at 1106 and on at 1108. The overlap of transistor 114 being on when transistor 118 is off is shown at overlap 1112. And the overlap of transistor 114 being on when transistor 118 is on is shown at 1110. Overlap 1110 is representative of the effective power input pulse of the control signal provided to transistors 114 and 118. Effective power input pulse 1110 represents a period of time where no power is transferred from input supply (e.g., voltage supply 102) to the resonant circuit (e.g., LC tank 121 and/or LC tank 123). Therefore, when the phase of the full-bridge rectifier is varies in phase (e.g., the phase is not always 1), there is an effective power input pulse (e.g., there will be overlap when transistors 114 and 118 are both on).

FIG. 12 shows an embodiment in which the operating frequency of transmitter 100 is the resonant frequency of transmitter 100 when the phase of full-bridge rectifier 110 is 0.5. The frequency of the control signals provided to transistors 114 and 118 (i.e., the operating frequency of transmitter 100) is equal to the resonant frequency of transmitter 100. At resonance, at the center of each effective power input pulse 1110 of low gate waveforms 1101 and 1103, voltage 1130 crosses zero and current 1120 is at its positive or negative peak value. The center of each effective power input pulse 1110 is represented with center line 1111. As shown in FIG. 12, when the operating frequency equals the resonant frequency, center 1111 corresponds to the voltage 1130 zero crossing and the current 1120 peak value. Transmitter 100 provides its maximum power when the operating frequency equals the resonant frequency.

FIG. 13 shows an embodiment in which the operating frequency of transmitter 100 is greater than the resonant frequency of transmitter 100 when the phase of full-bridge rectifier 110 is 0.5. The zero crossing of voltage 1130 and the peak of a current 1120 lags center 1111 of each effective power input pulse 1110 of low gate waveforms 1101 and 1103 (i.e., the control signal applied to transistors 114 and 118, respectively). The actual zero crossing of voltage 1130 occurs at position 1144, which is a higher frequency than the resonant frequency (e.g., taken from center 1111 of effective power input pulse 1110). The difference in frequency between the operating frequency (e.g., the frequency at position 1144) and the resonant frequency is difference 1144. The operating frequency is set to be approximately 2-20% greater than the resonant frequency. When the operating frequency of transmitter 100 is greater than the resonant frequency, the inductive reactance of LC tanks 121 and 123 are greater than the capacitive reactance of LC tanks 121 and 123, so the behavior of LC tanks 121 and 123 is inductive. Inductive behavior of LC tanks 121 and 123 is desirable for efficiency because it allows for zero-voltage switching of the transistors in full-bridge circuit 110.

As the phase of the full-bridge rectifier varies, the size and location of effective input power pulse also varies. Therefore, adjusting the operating frequency of transmitter 100 to ensure that the zero-voltage crossing of voltage 1130 is always slightly to the right of center 1111 of effective input power pulse 1110 ensures that the behavior of LC tanks 121 and 123 is inductive (e.g., allows for zero-voltage switching).

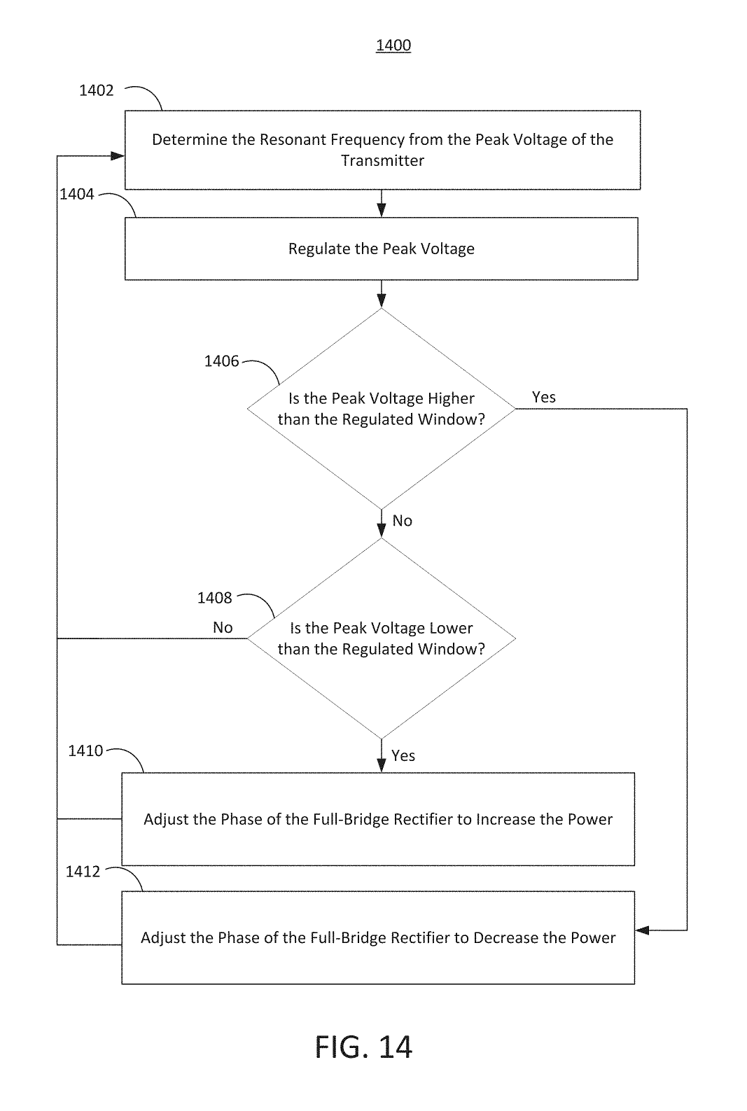

FIG. 14 is a flowchart of method steps for the operating of a wireless power transmitter, according to one embodiment of the invention. Process 1400 starts at step 1402, where controller 132 determines the resonant frequency of transmitter 100. Controller 132 may determine the resonant frequency of transmitter 100 by completing a frequency sweep (e.g., sweeping the operating frequency of the transmitter from 300 kHz down to 75 kHz) and determining the resonant frequency from the voltage peak waveform from node 129 (e.g., or node 180). The resonant frequency is equivalent to the operating frequency at the frequency in the sweep at the moment when the voltage peak waveform from node 129 begins to decrease when compared to a voltage peak waveform taken from a slightly higher frequency.

At step 1404, controller 132 regulates the peak voltage. For example, after controller 132 determines the optimized operating frequency by first locating the actual resonant frequency based on the peak amplitude of the voltage waveform at node 129 (e.g., or node 180), controller 132 then monitors the shape of the peak voltage waveform at node 129 (e.g., or node 180) by processing the rectified voltage signal from voltage detector 130 (e.g., or 128) to identify any changes to the resonant frequency and adjusts the phase of the full-bridge rectifier 110 as needed to maintain the peak voltage within a hysteretic window (e.g., such that the operating frequency of transmitter 110 is approximately 2-15% greater than the present resonant frequency). For example, controller 132 monitors the shape of the peak voltage waveform at node 129 (e.g., or node 180) to ensure that it is slight to the right of the center 1111 of effective input power pulse 1110 for a varying phase control scheme, as described above in relation to FIGS. 11-13. It should be noted that the peak voltage value signal from voltage detector 130 (e.g., or voltage detector 128) is a rectified and scaled-down representation of the voltage waveform at node 129 (e.g., or at node 180). The hysteretic window corresponds to a voltage window that keeps the peak voltage within 2-15% of the peak resonant voltage (e.g., and thus keeps the operating frequency of transmitter 110 within 2-15% of the resonant frequency).

At step 1406, controller 132 determines whether the peak voltage is higher than the voltage window. If at step 1406, controller 132 determines that “No,” The peak voltage (e.g., the rectified and scaled down peak voltage) is not higher than the upper limit of the voltage window (e.g., if the voltage window is 2.3 V to 3.5 V), then step 1406 proceeds to step 1408. At step 1408, controller 132 determines whether the peak voltage is lower than the voltage window. If, at step 1408, controller 132 determines that “No,” the peak voltage is not lower than the lower limit of the voltage window (e.g., if the voltage window is 2.3 V to 3.5 V), then step 1408 reverts to step 1402.

If, at step 1408, controller 132 determines that “Yes,” the peak voltage is lower than the lower limit of the voltage window, then step 1408 proceeds to step 1410. At 1410, controller 132 adjusts the phase of the full-bridge rectifier to increase the power. For example, controller 132 may increase the phase of the full-bridge rectifier (e.g., to get closer to a phase of 1, where the maximum power is transferred) to increase the power to the receiver, and raise the peak voltage to be within the voltage window.

In some embodiments, at step 1410, controller 132 may increase the power to the receiver by input voltage regulation via a DC-DC regulator, instead of phase modulation of the half-bridge converter. For example, controller 132 may increase the input voltage to increase the power to the receiver.

If at step 1406, controller 132 determines that “Yes,” The peak voltage is higher than the upper limit of the voltage window (e.g., if the voltage window is 2.3 V to 3.5 V), then step 1406 proceeds to step 1412. At step 1412, controller 132 adjusts the phase of the full-bridge rectifier to decrease the power. For example, if a receiver is suddenly removed from transmitter 100, the peak voltage from node 129 (e.g., or node 180) will become “peaky,” a characteristic of unloaded resonant circuits. This causes the peak voltage to suddenly increase. However, controller 132 will sense the sudden peak voltage spike and will keep the peak of the voltage at node 129 (e.g., the resonant voltage) within the voltage window. To reduce the peak voltage, controller 132 will reduce the phase of full-bridge rectifier 110, which in turn causes a smaller period of time during which a magnetization current is drawn into LC tank 121 and/or LC tank 123, thus reducing the peak voltage and reducing the power output by transmitter 100. Further, as the magnetization current component is the residual level responsible for the degradation in deficiency of a typical resonant power converter, reducing the magnetization current improves the efficiency of the power converter. Therefore as transmitter 100 reduces power to the receiver, the input current drawn by the transmitter will automatically decrease, and the efficiency of transmitter 100 will improve at lighter receiver loads. The reliability of transmitter 100 will also improve, as the peak voltage on the components in transmitter 100 (e.g., capacitors 124 and 126) will be controlled.

In some embodiments, at step 1412, controller 132 may decrease the power to the receiver by input voltage regulation via a DC-DC regulator, instead of phase modulation of the half-bridge converter. For example, controller 132 may decrease the input voltage to decrease the power to the receiver.

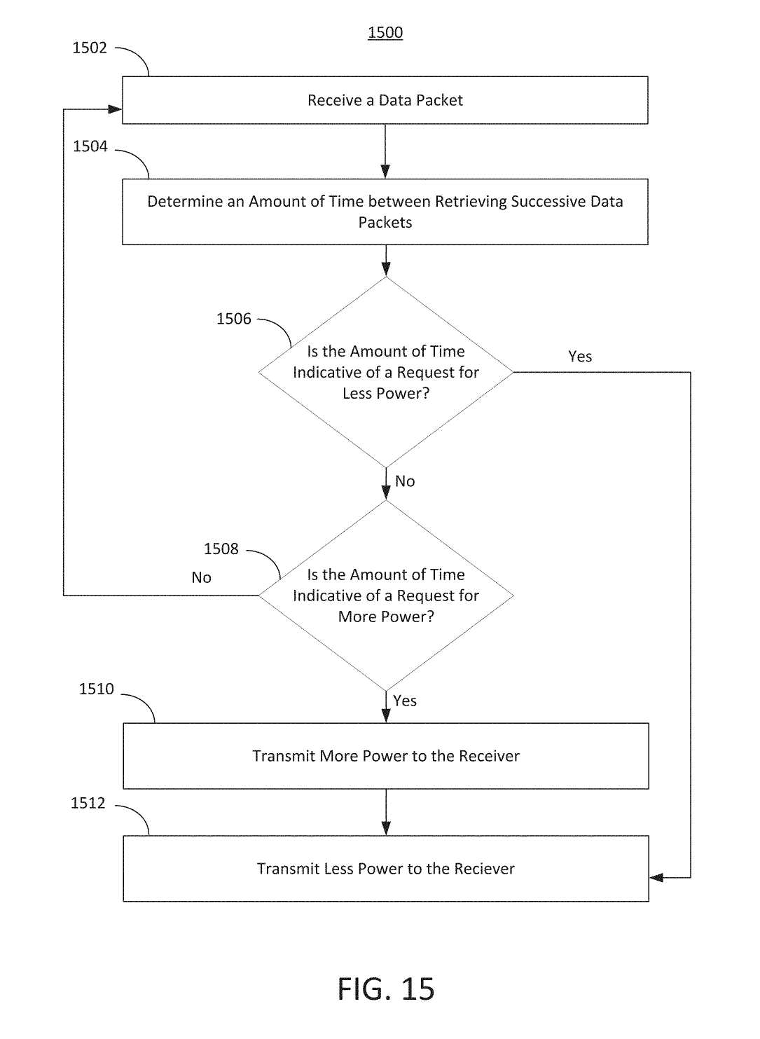

FIG. 15 is a flow chart of a method for a noise-immune method of communication, according to an embodiment of the invention. The noise-immune method of communication is generally applicable to both transverse-field (e.g., Proprietary mode) and vertical-field (e.g., dual-Qi mode) systems. The method of communication helps controller 132 of transmitter 100 quickly and clearly understand if more or less power is required by the receiver. Process 1500 begins at 1502, where a data packet is received by the transmitter. Controller 132 may receive the data packet from the receiver bit by bit. In some embodiments, the data packet may be a control error packet sent by the receiver. In some embodiments, the data packet may comprise of a series of bits with the value of “1.” In some embodiments, the bit encoding scheme of the data packet is identical to the bit encoding scheme employed in the Qi standard. In the Qi standard, bits with the value “1” constitute a swing within 250 μs. In the Qi standard, bits with the value “0” are fixed “high” or “low” for 500 μs and their waveforms tend to droop because the coupling capacitors in the demodulation circuitry of the receiver slowly charge/discharge over time. Therefore, reading bits with the value of “1” in the Qi standard encoding scheme is more reliable than reading bits with the value of “0.” In some embodiments, reading two to four successful bits corresponds to a successful data packet read. In some embodiments, if the data packet comprises bits all with values of “0,” controller 132 may determine that the receiver wants to end receiving power from transmitter 100.

At 1504, controller 132 determines an amount of time between receiving successive data packets. For example, controller 132 may receiving 10 data packets, each data packet was received 100 ms apart. As another example, controller 132 may determine that only 8 data packets of the 10 data packets were read by transmitter 100 (e.g., a data packet read at 100 ms, 200 ms, 300 ms, 500 ms, 600 ms, 800 ms, 900 ms, and 1000 ms). Controller 132 may still be able to interpret the receiver's request even though two data packets are missing, by determining that each data packet is sent 100 ms apart. Controller 132 may determine based on the pattern that each data packet is sent a fixed amount of time apart (e.g., either 100 ms apart or an integer multiple of 100 ms) that the data packet is indicative of a request for either more or less power from the receiver. Further, the spacing between sending successive data packets has a deliberate tolerance (e.g., typically +/−5 ms) to account for the width of each packet (e.g., the time it takes to send the bits in a single data packet).

At 1506, controller 132 determines whether the amount of time is indicative of a request for less power. For example, controller 132 may determine (e.g., based on a standard or predefined difference in time) that data packets being sent 100 ms apart is indicative of a request for less power, while data packets being sent 125 ms apart is indicative of a request for more power. The difference in time between a request for more power and a request for less power should be chosen such that their multiples rarely overlap (e.g., less than two or fewer overlaps every ten packets). If, at 1506, controller 132 determines that “No,” the amount of time is not indicative of a request for less power, then process 1506 proceeds to 1508. At 1508, controller 132 determines whether the amount of time is indicative of a request for more power. For example, controller 132 may determine (e.g., based on a standard or predefined difference in time) that data packets being sent 125 ms apart is indicative of a request for more power, while data packets being sent 100 ms apart is indicative of a request for less power.

If, at 1508, controller 132 determines that “No,” the amount of time is not indicative of a request for less power, then process 1506 reverts to 1502. If, at 1508, controller 132 determines that “Yes,” the amount of time is indicative of a request for more power, then process 1508 proceeds to 1510. At 1510, transmitter 100 transmits more power to the receiver. Transmitter 100 may transmit more power to the receiver using the methods described above. If, at 1506, controller 132 determines that “Yes,” the amount of time is indicative of a request for less power, then process 1508 proceeds to 1512. At 1512, transmitter 100 transmits less power to the receiver.

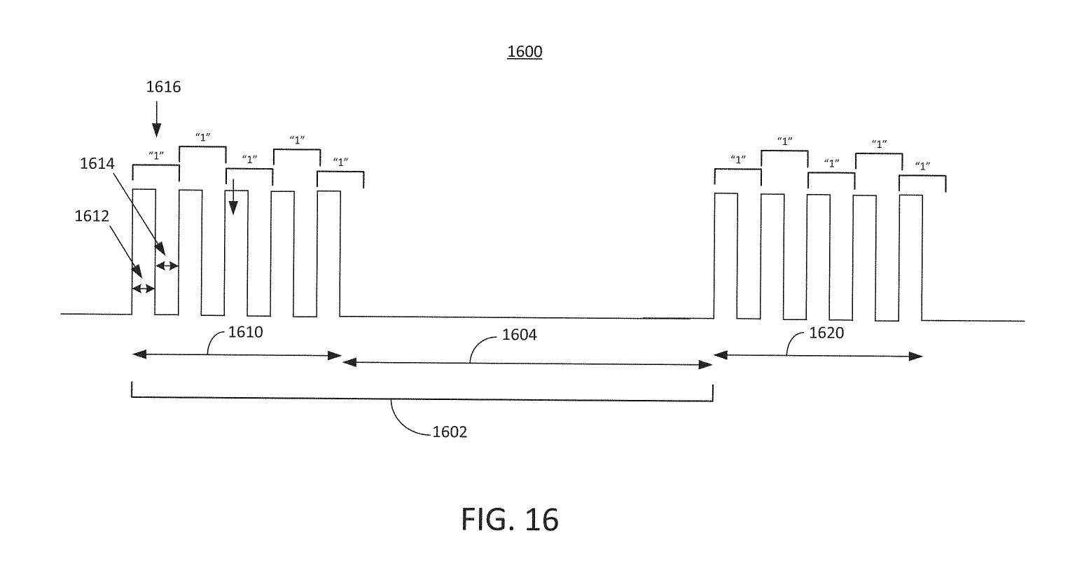

FIG. 16 shows an exemplary timing diagram for a noise-immune method of communication, according to an embodiment of the invention. Timing diagram 1600 comprises data packet 1610, data packet 1620, bit 1616, bit rise time 1612, bit fall time 1614, data packet sending time 1610, amount of time 1604 between receiving data packets, and total data packet send time 1602. In some embodiments, bit 1616 corresponds to a bit with a value of “1,” with bit rise time 1612 equaling approximately 250 μs and bit fall time 214 equaling 250 μs. Data packet sending time 1610 may be equivalent to the number of bits in a data packet multiplied by the summation of the bit rise time and bit fall time (e.g., 10 bits*(250 μs+250 μs)=5 ms). In some embodiments, amount of time 1604 between receiving data packets (e.g., the amount of time between the receiver sending data packets) is determined based on the type of request from the receiver. For example, amount of time 1604 is a different amount of time for when the receiver requests more power versus when the receiver requests less power from transmitter 100. In some embodiments, amount of time 104 may have a spacing of a multiple of 1.1 to 1.4 (e.g., when amount of time 1604 is a multiple of 1.1, a first data packet may be sent at 110 ms, a second data packet may be sent at 220 ms, a third data packet may be sent at 330 ms, etc.). Data packet total send time 1602 may be the summation of data packet sending time 1610 and amount of time 1604.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A wireless power transmitter for providing wireless power, the transmitter comprising:
a rectifier comprising a first coil coupled with a second coil; and
a switch having a first switch state and a second switch state and an output electrically coupled to a node between the first coil and the second coil, wherein
in the first switch state, the rectifier is configured to output a first current having a first polarity through the first coil and a second current having a second polarity through the second coil, the first polarity and the second polarity are different, and
in the second switch state, the rectifier is configured to output a third current having a third polarity through the first coil and the second coil.

2. The wireless power transmitter of claim 1, further comprising:
a controller coupled to the switch, the controller configured to:
control the configuration of the switch in the first switch state and in the second switch state.

3. The wireless power transmitter of claim 1, wherein when in the first switch state, the controller is further configured to:
control the transmitter at a predetermined frequency, wherein the predetermined frequency is higher than a maximum resonant frequency of the transmitter.

4. The wireless power transmitter of claim 3, wherein the predetermined frequency is a frequency in the range of 141 kHz to 150 kHz.

5. The wireless power transmitter of claim 2, wherein when in the second switch state, the controller is further configured to:
detect a resonant frequency of the transmitter;
determine an optimized frequency that is at least 2% greater than the detected resonant frequency; and
vary the phase of the rectifier to control the transmitter at the optimized frequency.

6. The wireless power transmitter of claim 1, further comprising:
a ferrite wall between the first coil and the second coil, the ferrite wall configured to decrease a flux leakage between the first coil and the second coil by providing a flux pathway for a first flux from the first coil and a second flux from the second coil.

7. The wireless power transmitter of claim 1, further comprising:
a biasing resistor coupled to the node, wherein the biasing resistor is configured to set a positive voltage at the node, wherein the node is further coupled to the switch, the first coil, and the second coil.

8. The wireless power transmitter of claim 1, further comprising:
a first LC tank, comprising:
a first capacitor coupled in series the first coil, wherein the first LC tank has a first resonant frequency; and
a second LC tank, comprising:
a second capacitor coupled in series with the second coil, wherein the second LC tank has the first resonant frequency.

9. The wireless power transmitter of claim 2, wherein the switch having an output electrically coupled to a node between the first coil and the second coil comprises:
a transistor, wherein the transistor receives one or more control signals from the controller;
a diode coupled in parallel with the transistor.

10. The wireless power transmitter of claim 9, wherein the diode comprises at least one of an external diode or a body diode of the transistor.

11. The wireless power transmitter of claim 1, further comprising:
a ferrite sheet beneath the first coil and the second coil, wherein the ferrite sheet is magnetically coupled to the first coil and the second coil.

12. A method for providing wireless power from a transmitter, the method comprising:
controlling the transmitter to operate in a first state at a predetermined frequency, the predetermined frequency being higher than a resonant frequency of the transmitter;
controlling the transmitter to operate in a second state at a variable frequency; and
in the second state, modulating a phase of the transmitter such that an operating frequency of the transmitter is at least 2% greater than the resonant frequency of the transmitter.

13. The method of claim 12, wherein the predetermined frequency is a frequency in the range of 141 kHz to 150 kHz.

14. The method of claim 12, wherein controlling the transmitter to operate in the first state further comprises:
detecting a presence of at least one Qi receiver.

15. The method of claim 14, further comprising:
in response to detecting the presence of a first Qi receiver and a second Qi receiver, controlling a first branch of the transmitter and a second branch of the transmitter at the predetermined frequency.

16. The method of claim 15, further comprising:
controlling a first duty cycle of a first rectifier of the first branch;
controlling a second duty cycle of a second rectifier of the second branch, wherein the first duty cycle and the second duty cycle are different.

17. The method of claim 13, further comprising:
in response to detecting the presence of a first Qi receiver:
controlling a first branch of the transmitter at the predetermined frequency; and
controlling a second branch of the transmitter such that it transmits a nominal amount of power.

18. The method of claim 12, wherein operating the transmitter in the first state further comprises:
detecting the resonant frequency of the transmitter, wherein the resonant frequency varies in response to varying power requests from a receiver.

19. The method of claim 12, wherein controlling the transmitter to operate in the second state further comprises:
detecting a resonant frequency of the transmitter; and
determining the optimized frequency of the transmitter that is at least 2% greater than the detected resonant frequency.

20. The method of claim 12, wherein controlling the transmitter to operate in the second state further comprises:
receiving a request from a receiver coupled to the transmitter requesting that the transmitter transmit more power to the receiver; and
increasing the phase of the transmitter to transmit more power to the receiver while maintaining the optimized operating frequency.

21. The method of claim 12, wherein controlling the transmitter to operate in the second state further comprises:
receiving a request from a receiver coupled to the transmitter requesting that the transmitter transmit more power to the receiver; and
decreasing the phase of the transmitter to transmit less power to the receiver while maintaining the optimized operating frequency.
